(19) United States
(12) Patent Application Publication
(10) Pub. No.: US 2021/0269063 A1
(43) Pub. Date: Sep. 2, 2021

(54) ELECTRONIC DEVICE FOR VEHICLES AND OPERATING METHOD OF ELECTRONIC DEVICE FOR VEHICLE

(71) Applicant: LG Electronics Inc., Seoul (KR)

(72) Inventors: Taekyung LEE, Seoul (KR); Duckgee PARK, Seoul (KR); Jaesaek OH, Seoul (KR)

(21) Appl. No.: 17/259,270

(22) PCT Filed: May 31, 2019
(86) PCT No.: PCT/KR2019/006625

§ 371 Date: Jan. 11, 2021

(51) Int. Cl. B60W 60/00; B60W 50/029; B60W 50/02; B60W 50/08; B60W 30/18; B60W 40/105; G07C 5/00

(52) U.S. Cl. CPC B60W 60/00186; B60W 50/029; B60W 50/0205; B60W 50/082; B60W 30/181; B60W 2050/0072; G07C 5/006; G07C 5/008; B60W 2050/0292; B60W 2050/0215; B60W 40/105

(57) ABSTRACT

The present disclosure relates to an electronic device for vehicles, which includes a processor configured to continuously generate emergency travel routes during implementation of an autonomous driving function and provide a control signal for causing the vehicle to travel along the emergency travel routes upon determining that at least one electronic device operating to implement the autonomous driving function has malfunctioned.

### TECHNICAL FIELD

The present disclosure relates to an electronic device for vehicles and an operating method of an electronic device for vehicles.

### BACKGROUND ART

Vehicles are apparatuses moved in a desired direction of users. A typical example is a car.

Meanwhile, vehicles tend to be provided with various sensors and electronic devices for convenience of users using the vehicles. Particularly, research on an advanced driver assistance system (ADAS) has been actively conducted for user convenience in driving. Furthermore, development of autonomous vehicles is actively conducted.

An autonomous driving function used for autonomous vehicles can be implemented by operations of a plurality of electronic devices. Malfunctions may occur in such electronic devices due to various factors. A malfunction in implementation of the autonomous deriving function may lead to car accidents.

### DISCLOSURE

### Technical Problem

Therefore, the present disclosure has been made in view of the above problems, and it is an object of the present disclosure to provide an electronic device for vehicles for implementing a vehicle control operation for handling occurrence of a malfunction when the autonomous driving function is implemented.

It is another object of embodiments of the present disclosure to provide an operating method of an electronic device for vehicles for implementing a vehicle control operation for handling occurrence of a malfunction when the autonomous driving function is implemented.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In accordance with the present disclosure, the above and other objects can be accomplished by the provision of an electronic device for vehicles which includes a processor for continuously generating emergency travel routes during implementation of an autonomous driving function and providing a control signal for causing the vehicle to travel along the emergency travel routes upon determining that at least one electronic device operating to implement the autonomous driving function has malfunctioned.

Details of other embodiments are included in the detailed description and drawings.

### Advantageous Effects

According to the present disclosure, one or more of the following effects are obtained.

It is possible to reduce occurrence of car accidents due to malfunction of autonomous driving by providing an electronic device for preventing a malfunction in autonomous driving.

It will be appreciated by persons skilled in the art that the effects that could be achieved with the present disclosure are not limited to what has been particularly described hereinabove and the above and other effects that the present disclosure could achieve will be more clearly understood from the following detailed description.

### DESCRIPTION OF DRAWINGS

FIG. 1 is a diagram illustrating the exterior of a vehicle according to an embodiment of the present disclosure.

FIG. 2 is a diagram for explaining objects according to an embodiment of the present disclosure.

FIG. 3 is a block diagram for explaining a vehicle and an electronic device for vehicles according to an embodiment of the present disclosure.

FIG. 4 is a flowchart for explaining operation of the electronic device for vehicles according to an embodiment of the present disclosure.

FIG. 5 is a diagram for explaining the electronic device for vehicles and the vehicle according to an embodiment of the present disclosure.

FIG. 6 is a diagram for explaining operation of the electronic device for vehicles according to an embodiment of the present disclosure.

FIGS. 7a and 7b are diagrams for explaining operation of the electronic device for vehicles according to an embodiment of the present disclosure.

FIGS. 8a to 9 are diagrams for explaining operations of the electronic device for vehicles and a user interface device according to an embodiment of the present disclosure.

FIG. 10 is a diagram for explaining operation of the electronic device for vehicles according to an embodiment of the present disclosure.

### BEST MODE

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A vehicle as described in this specification may include a car and a motorcycle. Hereinafter, a car will serve as an example of a vehicle.

A vehicle as described in this specification may include all of an internal combustion engine vehicle including an engine as a power source, a hybrid vehicle including both an engine and an electric motor as a power source, and an electric vehicle including an electric motor as a power source.

In the following description, the left side of a vehicle refers to the left side of a traveling direction of the vehicle and the right side of a vehicle refers to the right side of a traveling direction of the vehicle.

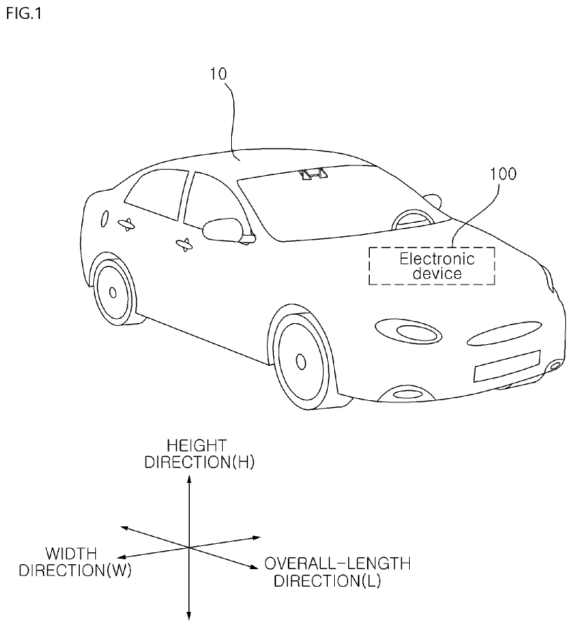

FIG. 1 is a diagram illustrating the exterior of a vehicle according to an embodiment of the present disclosure.

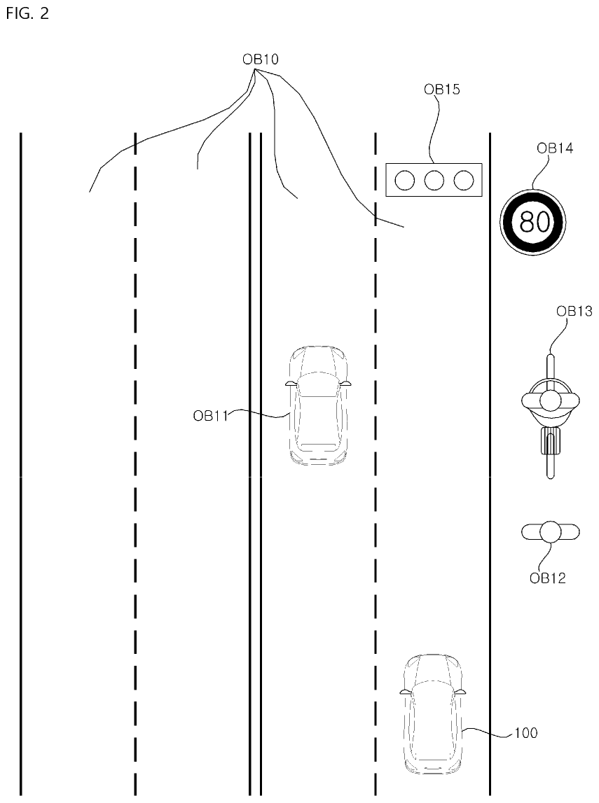

FIG. 2 is a diagram for explaining objects according to an embodiment of the present disclosure.

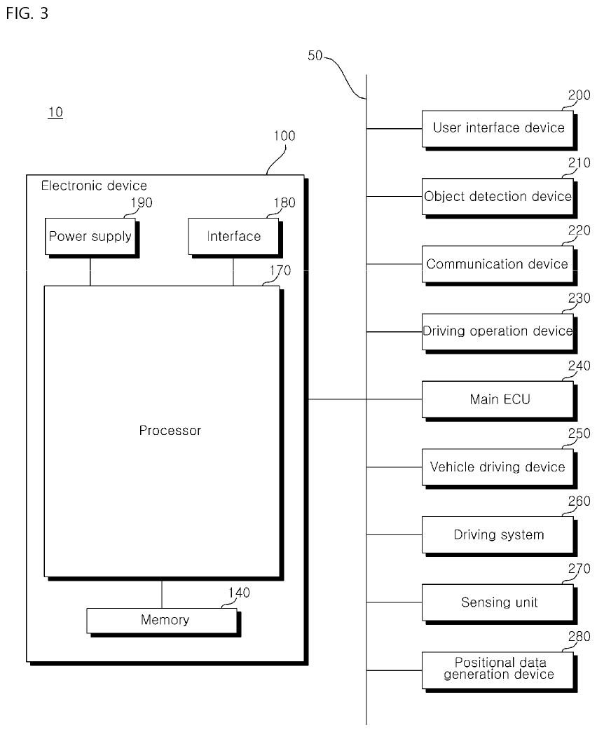

FIG. 3 is a block diagram for explaining a vehicle and an electronic device for vehicles according to an embodiment of the present disclosure.

Referring to FIGS. 1 to 3, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source.

The vehicle 10 may include an electronic device 100 for vehicles. The electronic device 100 for vehicles may be mounted in the vehicle 10. The electronic device 100 for vehicles may set sensing parameters of at least one range sensor on the basis of acquired data with respect to objects.

To implement functions of a driver assistance system 260, an object detection device 210 acquires data about objects outside the vehicle 10. Data about an object may include at least one of data about presence or absence of the object, data about the position of the object, data about a distance between the vehicle 10 and the object, and data about a relative speed of the vehicle 10 with respect to the object.

Objects may be various objects related to driving of the vehicle 10.

As illustrated in FIG. 2, objects O may include lanes OB10, another vehicle OB11, a pedestrian OB12, a two-wheeled vehicle OB13, traffic signals OB14 and OB15, lights, roads, structures, speed bumps, geographic features, animals, etc.

The lanes OB10 may include a travel lane, a lane next to a travel lane, and a lane in which an opposite vehicle travels. The lane OB10 may include left and right lines forming the lane. The lane may include crossroads.

Another vehicle OB11 may be a vehicle traveling around the vehicle 10. Another vehicle may be a vehicle located within a predetermined distance from the vehicle 10. For example, another vehicle OB11 may be a preceding or following vehicle of the vehicle 10.

The pedestrian OB12 may be a person located around the vehicle 10. The pedestrian OB12 may be a person located within a predetermined distance from the vehicle 10. For example, the pedestrian OB12 may be a person located on a sidewalk or a road.

The two-wheeled vehicle OB13 may refer to a vehicle which moves using two wheels and is located around the vehicle 10. The two-wheeled vehicle OB13 may be a vehicle having two wheels which is located within a predetermined distance from the vehicle 10. For example, the two-wheeled vehicle OB13 may be a motorcycle or a bicycle located on a sidewalk or a road.

The traffic signals may include a traffic light OB15, a traffic sign OB14 and a pattern or text on the surface of a road. The light may be light generated from lamps included in other vehicles. The light may be light generated from street lamps. The light may be sunlight. Roads may include a road surface, a curve, slopes including an uphill road and a downhill road, etc. The structures may be objects located around roads and fixed to the ground. For examples, the structures may include street trees, buildings, electric poles, traffic lights, bridges, curbs, and walls. The geographic features may include mountains, hills, etc.

Meanwhile, objects may be classified into a moving object and a stationary object. For example, the moving object may include other moving vehicles and moving pedestrians. For example, the stationary object may include traffic signals, roads, structures, other stopped vehicles, and stopped pedestrians.

The vehicle 10 may include an electronic device 100 for vehicles, a user interface device 200, the object detection device 210, a communication device 220, a driving operation device 230, a main ECU 240, a vehicle driving device 250, an ADAS application, a sensing unit 270 and a positional data generation device 280.

The electronic device 100 may be defined as a component for vehicles for handling occurrence of a malfunction in an autonomous driving function. The electronic device 100 can exchange signals with at least one of the object detection device 210, the communication device 220, the driving operation device 230, the main ECU 240, the vehicle driving device 250, a driving system 260, the sensing unit 270 and the positional data generation device 280.

According to an embodiment, the electronic device 100 may handle occurrence of a malfunction in the autonomous driving function while implementing the autonomous driving function.

The electronic device 100 can receive a signal from at least one of the user interface device 220, the object detection device 210, the communication device 220, the sensing unit 270 and the positional data generation device 280. The electronic device 100 can perform processing and determination on the basis of the received signal and generate a control signal on the basis of a processing result and a determination result. The electronic device 100 can provide the generated control signal to at least one of the vehicle driving device 250 and the driving system 260. Through this process, the electronic device 100 can implement the autonomous driving function.

The electronic device 100 can determine whether a malfunction has occurred with respect to at least one of the electronic device 100, the object detection device 210 and the positional data generation device 280 in implementation of the autonomous driving function. The electronic device 100 can perform a handling operation on the basis of a result of determination of whether a malfunction has occurred. Here, the handling operation may be referred to as a malfunction operation.

The electronic device 100 may include an interface 180, a power supply 190, a memory 140 and a processor 170.

The interface 180 can exchange signals with at least one electronic device included in the vehicle 10 in a wired or wireless manner. The interface 180 can exchange signals with at least one of the user interface device 200, the object detection device 210, the communication device 220, the driving operation device 230, the main ECU 240, the vehicle driving device 250, the ADAS application, the sensing unit 270 and the positional data generation device 280 in a wired or wireless manner. The interface 180 may be configured using at least one of a communication module, a terminal, a pin, a cable, a port, a circuit, an element and a device.

The interface 180 can exchange data with the communication device 220. The interface 180 can receive data about objects OB10, OB11, OB13, OB14 and OB15 outside the vehicle 10 from the communication device 220 provided in the vehicle 10. The interface 180 can receive data about objects outside the vehicle 10 from a camera provided in the vehicle 10.

The power supply 190 can provide power to the electronic device 100. The power supply 190 can be provided with power from a power source (e.g., a battery) included in the vehicle 10 and supply the power to each unit of the electronic device 100. The power supply 190 can operate according to a control signal supplied from the main ECU 240. The power supply 190 may be implemented as a switched-mode power supply (SMPS).

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one selected from the group of a ROM, a RAM, an EPROM, a flash drive and a hard drive. The memory 140 can store various types of data for overall operation of the electronic device 100, such as a program for processing or control of the processor 170. The memory 140 may be integrated with the processor 170. According to an embodiment, the memory 140 may be categorized as a subcomponent of the processor 170.

The processor 170 can be electrically connected to the interface 180 and the power supply 190 and exchange signals with these components. The processor 170 can be realized using at least one selected from among application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electronic units for executing other functions.

The processor 170 can be operated by power supplied from the power supply 190. The processor 170 can receive data, process the data, generate a signal and provide the signal while power is supplied thereto. Signals generated by the processor 170 can be provided to other electronic devices included in the vehicle 10. For example, the processor 170 can provide a signal corresponding to specific information to the user interface device 200. For example, the processor 170 can provide a control signal to at least one of the main ECU 240, the vehicle driving device 250 and the driving system 260.

The processor 170 can continuously generate emergency travel routes during implementation of the autonomous driving function. An emergency travel route can be defined as a temporary travel route when the autonomous driving function has malfunctioned. The processor 170 can continuously generate emergency travel routes in units of predetermined time in an autonomous driving state. For example, the processor 170 can continuously generate emergency travel routes for 1 minute during implementation of the autonomous driving function. The processor 170 can continuously generate emergency travel routes in units of predetermined distance in the autonomous driving state. For example, the processor 170 can continuously generate emergency travel routes to forward 1 km during implementation of the autonomous driving function. Further, the processor 170 can temporarily store a predetermined number of emergency travel routes, and the emergency travel routes can be deleted in generation order.

The processor 170 can continuously generate emergency travel routes while generating travel routes for implementing the autonomous driving function. The processor 170 can continuously generate emergency travel routes in units of predetermined time while generating travel routes for implementing the autonomous driving function. The processor 170 can continuously generate emergency travel routes in units of predetermined distance while generating travel routes for implementing the autonomous driving function.

The processor 170 can determine whether a malfunction has occurred in at least one electronic device operating to implement the autonomous driving function. The processor 170 can determine whether a malfunction has occurred on the basis of exchanged signals. For example, the processor 170 can transmit a test signal to at least one electronic device operating to implement the autonomous driving function and determine whether a malfunction has occurred on the basis of whether a response signal is received. The processor 170 can determine whether a malfunction has occurred on the basis of a result of comparison of generated data. For example, the processor 170 can determine whether a malfunction has occurred by comparing first data generated in a first electronic device, second data generated in a second electronic device and third data generated in a third electronic device.

The processor 170 can determine which one of a plurality of electronic devices operating to implement the autonomous driving function has malfunctioned. The processor 170 can perform different control operations according to which one of the plurality of electronic devices has malfunctioned.

The processor 170 can provide a control signal for causing the vehicle 10 to travel along an emergency travel route upon determining that a malfunction has occurred in at least one electronic control unit (ECU) performing determination and signal generation operations for implementing the autonomous driving function among the plurality of electronic devices. Upon determining that a malfunction has occurred, the processor 170 can provide a control signal for causing the vehicle 10 to travel along an emergency travel route generated immediately before occurrence of the malfunction.

The processor 170 can determine whether a malfunction has occurred in at least one electronic control unit (ECU) which performs determination and signal generation operations for implementing the autonomous driving function. Here, the ECU may be at least one of the processor 170, the main ECU 240, and a processor included in the driving system 260. Upon determining that a malfunction has occurred in at least one ECU which performs determination and signal generation operations for implementing the autonomous driving function, the processor 170 can stop implementation of the autonomous driving function. The processor 170 can attempt to reboot the at least one ECU.

The processor 170 can determine whether a malfunction has occurred in at least one sensor for generating sensing data with respect to an external object for implementation of the autonomous driving function. Here, the sensor may be at least one of a camera, a radar, a lidar, an ultrasonic sensor and an infrared sensor included in the object detection device 210.

The processor 170 can implement a restrictive autonomous driving function upon determining that a malfunction has occurred in at least one sensor for generating sensing data with respect to an external object for implementation of the autonomous driving function. The restrictive autonomous driving function may be defined as an autonomous driving function in which at least one of a travel speed, a travel road, a lane change function, a merging function and a branching function is restricted. The merging function can be understood as a function by which the vehicle 10 passes through a ramp section and enters a main road. Here, the vehicle 10 can enter between a plurality of other vehicles traveling on the main road. The branching function can be understood as a function by which the vehicle passes through a ramp section and branches from the main road to another road. Here, the vehicle 10 can exit between a plurality of vehicles traveling on the main road.

Upon determining that a malfunction has occurred in at least one sensor for generating sensing data with respect to an external object for implementation of the autonomous driving function, the processor 170 can provide a signal for outputting information about an area that cannot be detected by the sensor having the malfunction. The processor 170 can provide the information about the area that cannot be detected by the sensor having the malfunction to the user interface device 200. The user interface device 200 can perform image processing on the information and output the processed image.

The processor 170 can provide a signal for requesting switching to manual driving upon determining that a malfunction has occurred in at least one electronic device operating to implement the autonomous driving function. The processor 170 can provide the signal for requesting switching to manual driving to the user interface device 200. The user interface device 200 can display a manual driving switching request screen on the basis of the signal for requesting switching to manual driving while the vehicle 10 is traveling along emergency travel routes. A user can switch a driving mode of the vehicle 10 to manual driving while the vehicle 10 is traveling along emergency travel routes and drive the vehicle 10 through the driving operation device 230.

The processor 170 can provide a control signal for causing the vehicle 10 to stop on the shoulder of a road upon determining that the driving mode has not switched to manual driving until driving of the vehicle along emergency travel routes ends. The processor 170 can provide a control signal for causing the vehicle 10 to gradually reduce the speed thereof in a lane in which the vehicle 10 is traveling and then stop upon determining that the driving mode has not switched to manual driving until driving of the vehicle along emergency travel routes ends.

Meanwhile, the processor 170 can store data generated after occurrence of a malfunction. The processor 170 can provide data generated after occurrence of a malfunction to an external device of the vehicle through the communication device 220. The external device of the vehicle may be least one of a server and another vehicle.

The electronic device 100 may include at least one printed circuit board (PCB). The interface 180, the power supply 190, the memory 140 and the processor 170 can be electrically connected to the PCB.

The user interface device 200 is a device for communication between the vehicle 10 and a user. The user interface device 200 can receive user input and provide information generated in the vehicle 10 to the user. The vehicle 10 can implement a user interface (UI) or user experience (UX) through the user interface device 200.

The object detection device 210 can generate information about objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

The object detection device 210 can generate dynamic data on the basis of a sensing signal with respect to an object. The object detection device 210 can provide the dynamic data to the electronic device 100.

The communication device 220 can exchange signals with devices outside the vehicle 10. The communication device 220 can exchange signals with at least one of infrastructure (e.g., a server) and another vehicle. The communication device 220 may include a transmission antenna, a reception antenna, and at least one of a radio frequency (RF) circuit and an RF element which can implement various communication protocols in order to perform communication.

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an accelerator pedal) and a brake input device (e.g., a brake pedal).

The main ECU 240 can control the overall operation of at least one electronic device included in the vehicle 10.

The vehicle driving device 250 is a device for electrically controlling driving of various devices included in the vehicle 10. The vehicle driving device 250 may include a powertrain driver, a chassis driver, a door/window driver, a safety device driver, a lamp driver, and an air-conditioner driver. The powertrain driver may include a power source driver and a transmission driver. The chassis driver may include a steering driver, a brake driver and a suspension driver.

The driving system 260 can perform an operation of driving the vehicle 10. The driving system 260 can provide a control signal to at least one of the powertrain driver and the chassis driver among the vehicle driving device 250 to move the vehicle 10.

The driving system 260 may include at least one of the ADAS application and an autonomous driving application. The driving system 260 can generate a control signal according to at least one of the ADAS application and the autonomous driving application.

The ADAS application can control movement of the vehicle 10 or generate a signal for outputting information to a user on the basis of data about an object received from the object detection device 210. The ADAS application can provide the generated signal to at least one of the user interface device 200, the main ECU 240 and the vehicle driving device 250.

The ADAS application can implement at least one of adaptive cruise control (ACC), autonomous emergency braking (AB), forward collision warning (FCW), lane keeping assist (LKA), lane change assist (LCA), target following assist (TFA), blind spot detection (BSD), adaptive high beam assist (HEB), an auto parking system (APS), a PD collision warning system, traffic sign recognition (TSR), traffic sign assist (TSA), night vision (NV), driver status monitoring (DSM) and traffic jam assist (TJA).

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor according to steering wheel rotation, a vehicle internal temperature sensor, a vehicle internal humidity sensor, an ultrasonic sensor, an illumination sensor, an accelerator pedal position sensor and a brake pedal position sensor. Further, the IMU sensor may include one or more of an acceleration sensor, a gyro sensor and a magnetic sensor.

The sensing unit 270 can generate vehicle state data on the basis of a signal generated by at least one sensor. The sensing unit 270 may acquire sensing signals such as vehicle attitude information, vehicle motion information, vehicle yaw information, vehicle roll information, vehicle pitch information, vehicle collision information, vehicle orientation information, vehicle angle information, vehicle speed information, vehicle acceleration information, vehicle tilt information, vehicle forward/backward movement information, battery information, fuel information, tire information, vehicle lamp information, vehicle internal temperature information, vehicle internal humidity information, a steering wheel rotation angle, vehicle external illumination, a pressure applied to an acceleration pedal, a pressure applied to a brake panel, etc.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), etc.

The sensing unit 270 can generate vehicle state information on the basis of sensing data. The vehicle state information may be information generated on the basis of data detected by various sensors included in the vehicle.

For example, vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc.

The positional data generation device 280 can generate positional data of the vehicle 10. The positional data generation device 280 may include at least one of a global positioning system (GPS) and a differential global positioning system (DGPS). The positional data generation device 280 can generate positional data of the vehicle 10 on the basis of a signal generated from at least one of the GPS and the DGPS. According to an embodiment, the positional data generation device 280 can correct positional data on the basis of at least one of the inertial measurement unit (IMU) sensor of the sensing unit 270 and the camera of the object detection device 210.

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

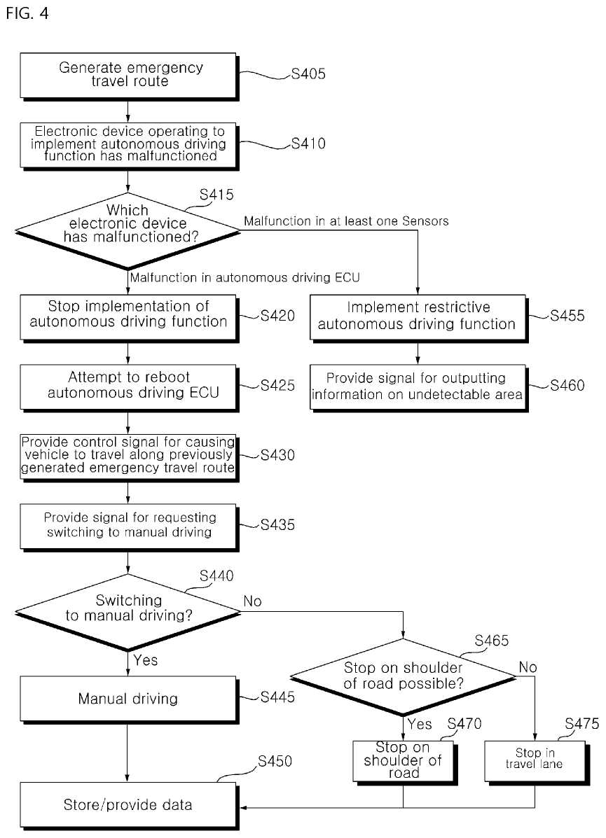

FIG. 4 is a flowchart for explaining operation of the electronic device for vehicles according to an embodiment of the present disclosure.

Referring to FIG. 4, the processor 170 may continuously generate emergency travel routes during implementation of the autonomous driving function (S405).

The emergency travel routes can be defined as temporary travel routes when the autonomous driving function has malfunctioned. The processor 170 can continuously generate emergency travel routes in units of a predetermined time in an autonomous driving state. For example, the processor 170 can continuously generate emergency travel routes for 1 minute during implementation of the autonomous driving function. The processor 170 can continuously generate emergency travel routes in units of predetermined distance in an autonomous driving state. For example, the processor 170 can continuously generate emergency travel routes to forward 1 km during implementation of the autonomous driving function. Further, the processor 170 may temporarily store a predetermined number of emergency travel routes, and the emergency travel routes may be deleted in generation order. The processor 170 may determine whether a malfunction has occurred in at least one electronic device operating to implement the autonomous driving function (S410). The processor 170 may determine whether a malfunction has occurred on the basis of transmitted/received signals. For example, the processor 170 may transmit a test signal to at least one electronic determine device operating to implement the autonomous driving function and determine whether a malfunction has occurred on the basis of whether a response signal is received. The processor 170 may determine whether a malfunction has occurred on the basis of a result of comparison of generated data. For example, the processor 170 may determine whether a malfunction has occurred by comparing first data generated in a first electronic device, second data generated in a second electronic device and third data generated in a third electronic device.

The processor 170 may determine which one of a plurality of electronic devices has malfunctioned (S415).

The processor 170 may perform different control operations according to which one of the plurality of electronic devices has malfunctioned (S420 to S475).

The processor 170 may perform at least one operation of S420, S425, S430, S435, S440, S445, S450, S465, S470 and S475 upon determining that a malfunction has occurred in at least one electronic control unit (ECU) performing determination and signal generation operations for implementing the autonomous driving function among the plurality of electronic devices.

The processor 170 may stop implementation of the autonomous driving function upon determining that a malfunction has occurred in at least one electronic control unit (ECU) performing determination and signal generation operations for implementing the autonomous driving function (S420). Here, the ECU may be at least one of the processor 170, the main ECU 240, and a processor included in the driving system 260. The processor 170 may attempt to reboot the at least one ECU (S425). The processor 170 may provide a control signal for causing the vehicle 10 to travel along emergency travel routes (S430). Upon determining that a malfunction has occurred, the processor 170 may provide a control signal for causing the vehicle 10 to travel along an emergency travel route generated immediately before occurrence of the malfunction.

The processor 170 may provide a signal for requesting switching to manual driving upon determining that a malfunction has occurred in at least one electronic device operating to implement the autonomous driving function (S435). The processor 170 may provide the signal for requesting switching to manual driving to the user interface device 200. The user interface device 200 may display a manual driving switching request screen on the basis of the signal for requesting switching to manual driving while the vehicle 10 is traveling along emergency travel routes. A user can switch the driving mode of the vehicle 10 to manual driving while the vehicle 10 is traveling along emergency travel routes and drive the vehicle 10 through the driving operation device 230.

When the driving mode has switched to manual driving (S440), the vehicle 10 can travel in the manual driving mode (S445). The processor 170 transfers the right to control the vehicle 10 to the user.

The processor 170 may store data generated after occurrence of a malfunction (S450). The processor 170 may provide data generated after occurrence of the malfunction to an external device of the vehicle through the communication device 220 (S450). The external device of the vehicle may be at least one of a server and another vehicle.

The processor 170 may implement a restrictive autonomous driving function (S455) upon determining that a malfunction has occurred in at least one sensor for generating sensing data with respect to an external object for implementation of the autonomous driving function in step S415. The restrictive autonomous driving function may be defined as an autonomous driving function in which at least one of a travel speed, a travel road, a lane change function, a merging function and a branching function is restricted. The merging function can be understood as a function by which the vehicle 10 passes through a ramp section and enters a main road. Here, the vehicle 10 can enter between a plurality of other vehicles traveling on the main road. The branching function can be understood as a function by which the vehicle passes through a ramp section and branches from the main road to another road. Here, the vehicle 10 can exit between a plurality of vehicles traveling on the main road.

Upon determining that a malfunction has occurred in at least one sensor for generating sensing data with respect to an external object for implementation of the autonomous driving function, the processor 170 may provide a signal for outputting information about an area that cannot be detected by the sensor having the malfunction (S460). The processor 170 may provide the information about the area that cannot be detected by the sensor having the malfunction to the user interface device 200. The user interface device 200 may perform image processing on the information and output the processed image. Thereafter, the processor 170 may perform step S450.

Upon determining that stopping on the shoulder of a road can be performed (S465) in a state in which it is determined that the driving mode has not switched to manual driving until driving of the vehicle along emergency travel routes ends in step S440, the processor 170 may provide a control signal for causing the vehicle 10 to stop on the shoulder of the road (S470). Then, the processor 170 may perform step S450.

On the other hand, upon determining that stopping on the shoulder of a road cannot be performed (S465) in a state in which it is determined that the driving mode has not switched to manual driving until driving of the vehicle along emergency travel routes ends in step S440, the processor 170 may provide a control signal for causing the vehicle 10 to gradually reduce the speed in a lane in which the vehicle 10 is traveling and then stop (S475). Then, the processor 170 may perform step S450.

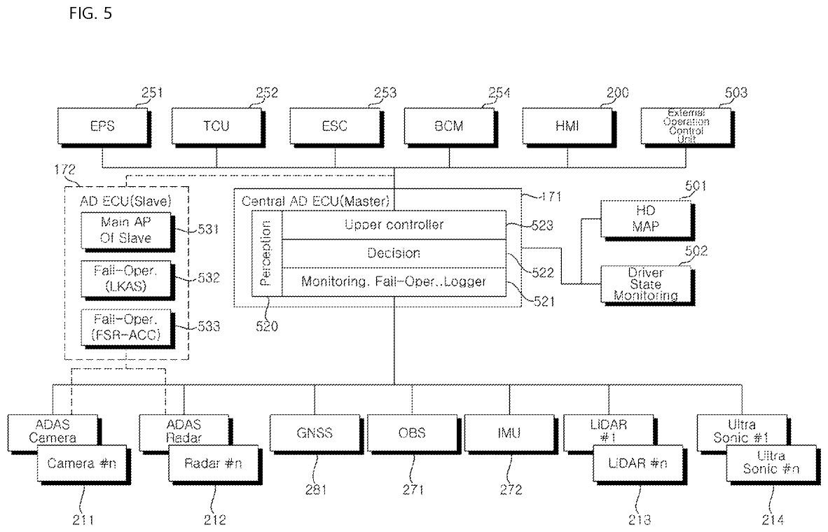

FIG. 5 is a diagram for explaining the electronic device for vehicles and the vehicle according to an embodiment of the present disclosure.

Referring to FIG. 5, the processor 170 may include a first processor 171 and a second processor 172. The first processor 171 can perform a processing operation for implementing the autonomous driving function and the second processor 172 can perform an operation of handling a malfunction of the autonomous driving function.

The first processor 171 may be electrically connected to the object detection device 210, the sensing unit 270, the positional data generation device 280, the user interface device 200, the vehicle driving device 250, an HD map providing device 501, a driver state monitoring (DSM) device 502, and a control device 503. The object detection device 210 may include at least one camera 211, at least one radar 212, at least one lidar 213 and at least one ultrasonic sensor 214. The sensing unit 270 may include an on board sensor (OBS) 271 and an inertial measurement unit (IMU) 272. The positional data generation device 280 may include a global navigation satellite system (GNSS) 281. The vehicle driving device 250 may include electronic power steering (EPS) 251, a transmission control unit (TCU) 252, electronic stability control (ESC) 253, and a body control module (BCM) 254. The first processor 171 can be electrically connected to the second processor 172.

The first processor 171 may include a perception unit 520, a monitoring unit 521, a decision unit 522 and a signal generation unit 523.

The perception unit 520 can ascertain a state of the vehicle 10 on the basis of data received from the object detection device 210, the sensing unit 270, the positional data generation device 280 and the DSM device 502. The perception unit 520 can perceive a travel state of the vehicle 10, a surrounding state of the vehicle 10, an internal state of the vehicle 10, etc.

The monitoring unit 521 can continuously monitor a state of the vehicle 10. The monitoring unit 521 can store a monitored state of the vehicle 10. The monitoring unit 521 can determine whether the autonomous driving function malfunctions.

The decision unit 522 can decide an operation of the vehicle 10 on the basis of data generated by at least one of the perception unit 520 and the monitoring unit 521. The decision unit 522 can decide an operation of the vehicle 10 additionally using HD map data 501 and DSM data 502.

The signal generation unit 523 can generate a signal on the basis of data generated by the decision unit 522. The signal generation unit 523 can generate a control signal and provide the control signal to the vehicle driving device 250. The signal generation unit 523 can generate an information provision signal and provide the information provision signal to the user interface device 200.

According to an embodiment, the first processor 171 can receive a signal from the control device 503 and perform processing/control operation on the basis of the received signal.

The second processor 172 can be electrically connected to the object detection device 210, the sensing unit 270, the positional data generation device 280, the user interface device 200, the vehicle driving device 250, the HD map providing device 501, the driver state monitoring (DSM) device 502, and the external control device 503. The second processor 172 can be electrically connected to the first processor 171.

The second processor 172 may include a main processing unit 531, a first malfunction operation unit 532 and a second malfunction operation unit 532.

The main processing unit 531 can continuously generate emergency travel routes during implementation of the autonomous driving function. The main processing unit 531 may generate a control signal for causing the vehicle 10 to travel along emergency travel routes upon determining that a malfunction has occurred in at least one electronic device operating to implement the autonomous driving function. The main processing unit 531 may stop implementation of the autonomous driving function upon determining that a malfunction has occurred in the first processor 171. The main processing unit 531 may attempt to reboot the first processor 171. Upon determining that a malfunction has occurred in at least one sensor for generating sensing data with respect to an external object for implementation of the autonomous driving function, the main processing unit 531 can generate a signal for outputting information about an area that cannot be detected by the sensor having the malfunction. The main processing unit 531 can generate a signal for requesting switching to manual driving upon determining that a malfunction has occurred in at least one electronic device operating to implement the autonomous driving function. The main processing unit 531 can provide a control signal for causing the vehicle 10 to stop on the shoulder of a road upon determining that the driving mode has not switched to manual driving until driving of the vehicle along emergency travel routes ends. The main processing unit 531 can provide a control signal for causing the vehicle 10 to gradually reduce the speed thereof in a lane in which the vehicle 10 is traveling and then stop upon determining that the driving mode has not switched to manual driving until driving of the vehicle along emergency travel routes ends. The main processing unit 531 can store data generated after occurrence of the malfunction.

The first malfunction operation unit 532 and the second malfunction operation unit 533 can implement a restrictive autonomous driving function upon determining that a malfunction has occurred in at least one sensor for generating sensing data with respect to an external object for implementation of the autonomous driving function. The first malfunction operation unit 532 can generate a control signal such that a lane keeping assist system (LKAS) is implemented in the vehicle 10. The second malfunction operation unit 533 can generate a control signal such that full-speed range adaptive cruise control (FSR-ACC) is implemented. The restrictive autonomous driving function can be implemented according to implementation of the LKAS and FSR-ACC.

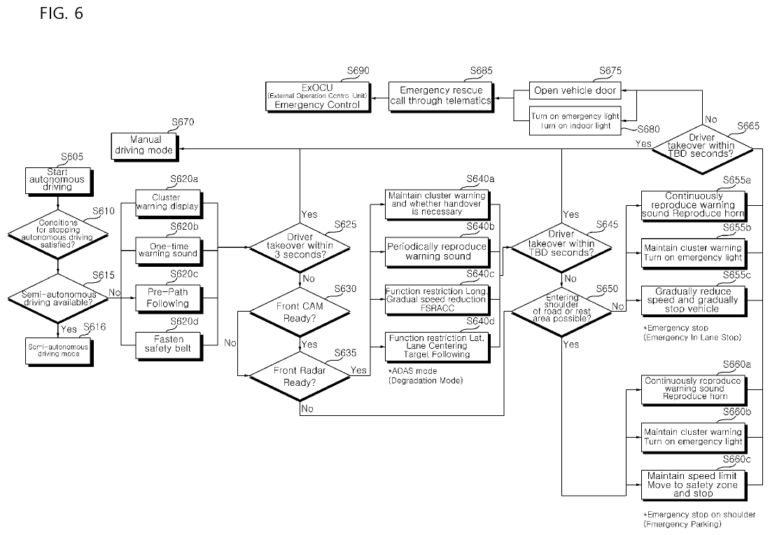

FIG. 6 is a diagram for explaining operation of the electronic device for vehicles according to an embodiment of the present disclosure.

Referring to FIG. 6, the processor 170 may implement the autonomous driving function (S605). The processor 170 may determine whether conditions for stopping autonomous driving are satisfied (S610). For example, the processor 170 may determine whether a malfunction has occurred in at least one ECU which performs determination and signal generation operations to implement the autonomous driving function. When the conditions for stopping autonomous driving are satisfied, the processor 170 may determine whether semi-autonomous driving is available (S615). Semi-autonomous driving can be understood as the aforementioned restrictive autonomous driving. When semi-autonomous driving is determined to be available, the processor 170 may provide a control signal for causing the vehicle 10 to travel in a semi-autonomous driving mode (S616).

The semi-autonomous driving mode can be understood as a mode in which only functions that can be implemented are executed and the remaining functions are restricted when full autonomous driving is unavailable. In this case, a driver can select restricted functions and control driving such that driving is maintained only with available functions according to error type when an error signal is generated. For example, when a side sensor has malfunctioned, a lane change function of the vehicle may not be supported. In this case, only LKAS and FSR-ACC are executed and lane change may be manually performed. The semi-autonomous driving mode may be executed through DSM only when a user keeps eyes forward as necessary. When a sensor for multi-object tracking (MOT) has malfunctioned, lane keeping and speed control functions can be supported. In this case, distance control is not supported. This can be used in environments having little traffic.

When semi-autonomous driving is not available in step S615, the processor 170 may provide a signal for visual or auditory warning message output to the user interface device (S620a and S620b). Further, the processor 170 may provide a control signal for causing the vehicle 10 to travel along emergency travel routes generated in advance (S620c). Further, the processor 170 may provide a control signal for causing a passenger to fasten a seat belt (S620d).

The processor 170 may determine whether the driving mode has switched to manual driving within a predetermined time (S625). When the driving mode has switched to manual driving, the vehicle 10 can switch to the manual driving mode and travel therein (S670). When the driving mode has not switched to manual driving, the vehicle 10 can determine whether a front camera and/or a front radar can be used (S630 and S635).

When at least one of the front camera and the front radar can be used, the processor 170 may provide a signal for visually outputting a warning message and a manual driving switching request message to the user interface device (S640a). The processor 170 may provide a signal for periodically outputting an auditory warning message to the user interface device (S640b). The processor 170 may restrict functions with respect to forward and backward directions, gradually reduce the speed of the vehicle 10 and execute the FSR-ACC function (S640c). The processor 170 may restrict functions with respect to left and right directions, locate the vehicle 10 at the center of a lane and provide a signal for tracking a target (S640d). Meanwhile, steps S640c and S640d may be referred to as a degradation mode or an ADAS mode.

The processor 170 may determine whether the driving mode has switched to manual driving within a predetermined time (S645). When the driving mode has switched to manual driving, the vehicle 10 may switch to the manual driving mode and travel therein (S670). When the driving mode has not switched to manual driving, the processor 170 may determine whether the vehicle 10 can enter the shoulder of a road or a rest area (S650). When it is determined that the vehicle 10 cannot enter the shoulder of a road or a rest area in step S650, the processor 170 may provide a signal for continuously outputting an auditory warning message to the user interface device (S655a). The processor 170 may provide a signal for maintaining a visual warning message to the user interface device and provide a signal for turning an emergency light off (S655b). The processor 170 may provide a control signal for causing the vehicle 10 to gradually reduce the speed thereof and stop in a lane in which the vehicle 10 is traveling (S655c). When it is determined that the vehicle 10 can enter the shoulder of a road or a rest area in step S650, the processor 170 may provide a signal for continuously outputting an auditory warning message to the user interface device (S660a). The processor 170 may provide a signal for maintaining a visual warning message to the user interface device and provide a signal for turning an emergency light off (S660b). The processor 170 may provide a control signal for causing the vehicle 10 to move to a safety zone and stop therein while maintaining a speed limit (S660c).

The processor 170 may determine whether the driving mode has switched to manual driving within a predetermined time (S665). When the driving mode has switched to manual driving, the vehicle 10 may switch to the manual driving mode and travel therein (S670). When the driving mode has not switched to manual driving, the processor 170 may provide a control signal for opening a vehicle door (S675). The processor 170 may provide a control signal such that an emergency light is turned on and a dome light is turned on (S680). The processor 170 may provide a signal such that emergency rescue call through telematics is performed (S685). The professor 170 may receive an emergency control signal from the control device and perform emergency control (S690).

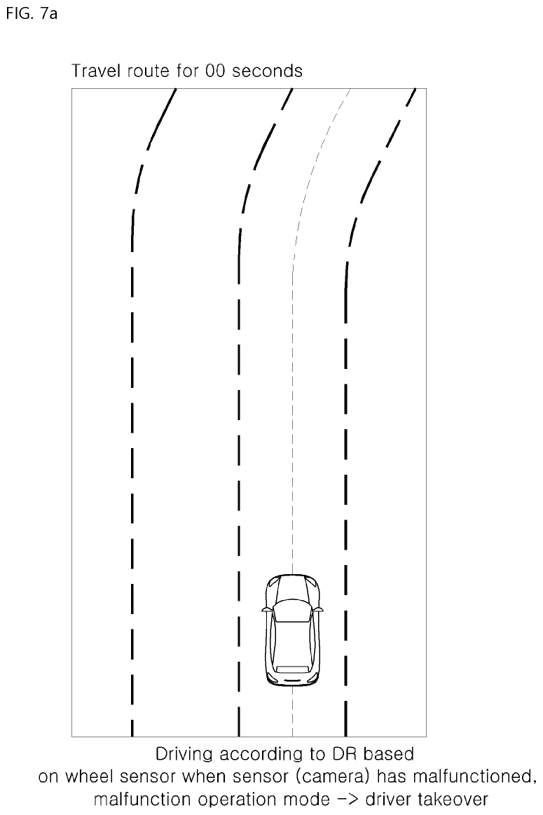

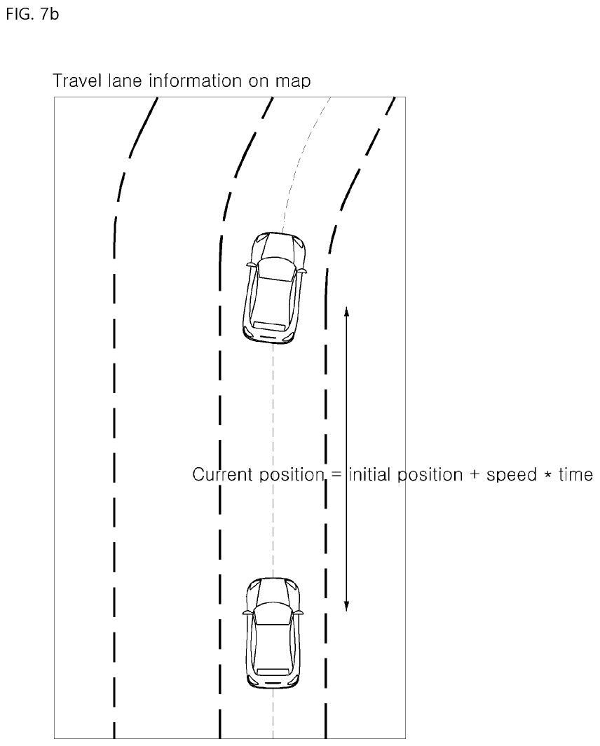

FIGS. 7a and 7b are diagrams for explaining operation of the electronic device for vehicles according to an embodiment of the present disclosure.

Referring to FIG. 7a, the electronic device 100 for vehicles can generate emergency travel routes through which the vehicle 10 will travel for a predetermined time during normal autonomous driving. When a sensor of the object detection device 210 has malfunctioned, the electronic device 100 for vehicles can provide a control signal for causing the vehicle 10 to safely travel along emergency travel routes predefined through dead reckoning on the basis of data generated by sensors (e.g., a wheel sensor and an IMU) of the sensing unit 270. The electronic device 100 for vehicles can switch to the original state when the driving mode has switched to manual driving or sensors normally operate.

Referring to FIG. 7b, the electronic device 100 for vehicles can perceive a road on which the vehicle 10 is traveling. When a GPS has malfunctioned, the electronic device 100 for vehicles can detect an approximate location of the vehicle 10 on a map on the basis of the speed of the vehicle 10 and a time for which the vehicle 10 has traveled. When the electronic device 100 for vehicles can detect road information, the electronic device 100 can ascertain a point having a minimum error by comparing lane information acquired through a camera with lane information on the map. The electronic device 100 for vehicles can correct a final location of the vehicle 10 on the basis of the information on the point having the minimum error. When the electronic device 100 for vehicles acquires land mark (e.g., a traffic sign or a guard rail) data, the electronic device 100 can correct the location of the vehicle 10 on the basis of the land mark data.

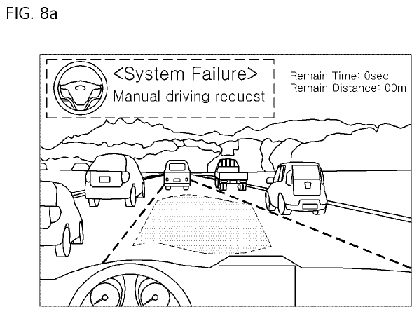

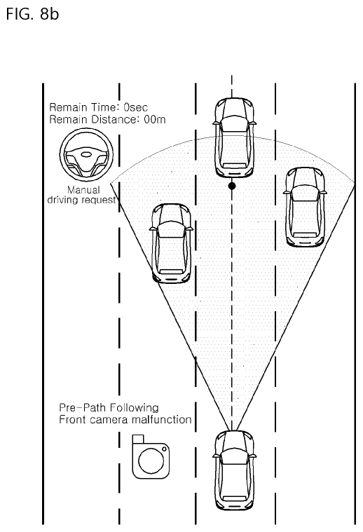

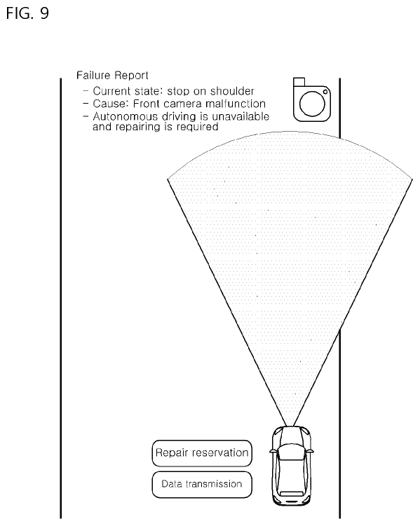

FIGS. 8a to 9 are diagrams for explaining operations of the electronic device for vehicles and the user interface device according to an embodiment of the present disclosure.

Referring to FIGS. 8a and 8b, the user interface device 200 can output visual information on the basis of a signal received from the electronic device 100 for vehicles. The user interface device 200 can output the visual information through an augmented reality head-up display (AR HUD) or at least one display attached to a dashboard. The user interface device 200 can display an emergency travel route on the AR HUD and cluster when a malfunction has occurred in the autonomous driving function. The user interface device 200 can display the remaining time and distance of the emergency travel route. The user interface device 200 can induce a user to perceive the malfunction by displaying the color, line, shape and end form of the emergency travel route differently from those in a normal state. The user interface device 200 can display a driver switching request (switching to manual driving). The user interface device 200 can display a malfunction operation mode that is being executed. For example, the user interface device 200 can display information about whether the vehicle is traveling along an emergency travel route, ADAS information, information about stop on the shoulder of a road, and emergency stop information. The user interface device 200 can display an area that cannot be detected due to a sensor having a malfunction using a shade.

Referring to FIG. 9, the user interface device 200 can output details corresponding to a malfunction operation, malfunction generation parts, and countermeasure monitoring information after the malfunction operation ends. The user interface device 200 can receive user input for traction request, repair reservation, related data transmission, and the like.

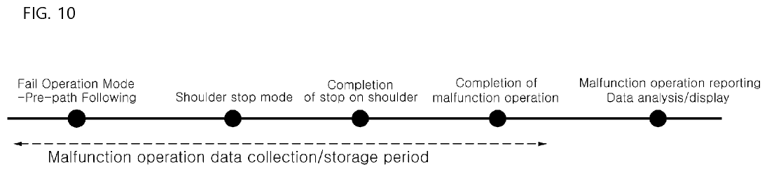

FIG. 10 is a diagram for explaining operation of the electronic device for vehicles according to an embodiment of the present disclosure.

Referring to FIG. 10, the processor 170 can generate signals for collecting, storing, analyzing and outputting data before and after a malfunction operation.

The processor 170 can store malfunction occurrence time data and elapsed time data. The processor 170 can store data with respect to a malfunction operation (e.g., traveling along an emergency travel route, degradation, stop on the shoulder of a road, emergency stop, emergency rescue call, automatic error recovery, and user takeover). The processor 170 can store data with respect to a sensor state (e.g., a defective camera image or defective radar data). The processor 170 can store data with respect to a system state (e.g., first processor error or second processor error). The processor 170 can store sensor information (e.g., positioning data, GPS and dead reckoning) and control information (acceleration/deceleration and steering). The processor 170 can store trajectory data of the vehicle 10.

The processor 170 can analyze the cause of occurrence of a malfunction. The processor 170 can analyze whether a malfunction is a sensor hardware error, a sensor software error, an ECU hardware error or an ECU software error. The processor 170 can determine a malfunction type. The processor 170 can determine whether a malfunction is a temporary error or an error that requires checking/repairing. In the case of a temporary error, recovery can be completed after system rebooting. The processor 170 can transmit malfunction data to the vehicle manufacturer as necessary.

The above-described present disclosure can be implemented with computer-readable code in a computer-readable medium in which a program has been recorded. The computer-readable medium may include all kinds of recording devices capable of storing data readable by a computer system. Examples of the computer-readable medium may include a hard disk drive (HDD), a solid state drive (SSD), a silicon disk drive (SDD), a ROM, a RAM, a CD-ROM, magnetic tapes, floppy disks, optical data storage devices, and the like and also include carrier-wave type implementation (for example, transmission over the Internet). Further, the computer may include a processor or a controller. Therefore, the above embodiments are to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

### REFERENCE SIGNS LIST

10: Vehicle

100: Electronic device for vehicle

1. An electronic device for vehicles, comprising:
a processor configured to:
continuously generate emergency travel routes during implementation of an autonomous driving function
perform different control operations according to which one of a plurality of electronic devices operating to implement the autonomous driving function has malfunctioned, and
provide a control signal for traveling along the emergency travel routes upon determining that at least one electronic control unit (ECU) has malfunctioned, the at least one ECU performing determination and signal generation operations to implement the autonomous driving function from among the plurality of electronic devices.

2. The electronic device for vehicles according to claim 1, wherein the processor is configured to stop implementation of the autonomous driving function upon determining that at least one ECU has malfunctioned.

3. The electronic device for vehicles according to claim 2, wherein the processor is configured to attempt to reboot the at least one ECU.

4. The electronic device for vehicles according to claim 1, wherein the processor is configured to implement a restrictive autonomous driving function upon determining that at least one sensor for generating sensing data with respect to an external object for implementation of the autonomous driving function has malfunctioned.

5. The electronic device for vehicles according to claim 4, wherein the restrictive autonomous driving function is an autonomous driving function in which at least one of a travel speed, a travel road, a lane change function, a merging function and a branching function is restricted.

6. The electronic device for vehicles according to claim 4, wherein the processor is configured to provide a signal for outputting information about an area undetectable by a malfunctioned sensor.

7. The electronic device for vehicles according to claim 1, wherein the processor is configured to provide a signal for requesting switching to manual driving upon determining that at least one electronic device operating to implement the autonomous driving function has malfunctioned.

8. The electronic device for vehicles according to claim 7, wherein the processor is configured to provide a control signal for stopping on the shoulder of a road upon determining that switching to manual driving is not performed until traveling of the vehicle along the emergency travel routes ends.

9. The electronic device for vehicles according to claim 7, wherein the processor is configured to provide a control signal for gradually reducing the travel speed in a lane in which the vehicle is traveling and stopping upon determining that switching to manual driving is not performed until traveling of the vehicle along the emergency travel routes ends.

10. The electronic device for vehicles according to claim 9, wherein the processor is configured to store data generated after a malfunction has occurred and provide the data to an external device of the vehicle.

11. An operating method of an electronic device for vehicles, the operating method comprising:
continuously generating, by at least one processor, emergency travel routes during implementation of an autonomous driving function;
determining, by at least one processor, which one of a plurality of electronic devices operating to implement the autonomous driving function has malfunctioned; and
performing, by at least one processor, different control operations according to which one of the plurality of electronic devices has malfunctioned,
wherein the performing of different control operations comprises providing, by at least one processor, a control signal for traveling along the emergency travel routes upon determining that at least one electronic control unit (ECU) has malfunctioned, the at least one ECU performing determination and signal generation operations to implement the autonomous driving function from among the plurality of electronic devices.

12. The operating method according to claim 11, wherein the performing of different control operations further comprises stopping, by at least one processor, implementation of the autonomous driving function upon determining that at least one ECU has malfunctioned.

13. The operating method according to claim 12, wherein the performing of different control operations further comprises attempting, by at least one processor, to reboot the at least one ECU.

14. The operating method according to claim 11, wherein the performing of different control operations further comprises implementing, by at least one processor, a restrictive autonomous driving function upon determining that at least one sensor for generating sensing data with respect to an external object for implementation of the autonomous driving function has malfunctioned.

15. The operating method according to claim 14, wherein the restrictive autonomous driving function is an autonomous driving function in which at least one of a travel speed, a travel road, a lane change function, a merging function and a branching function is restricted.

16. The operating method according to claim 14, wherein the performing of different control operations further comprises providing, by at least one processor, a signal for outputting information about an area undetectable by a malfunctioned sensor.

17. The operating method according to claim 11, wherein the performing of different control operations further comprises providing, by at least one processor, a signal for requesting switching to manual driving upon determining that at least one electronic device operating to implement the autonomous driving function has malfunctioned.

18. The operating method according to claim 17, wherein the performing of different control operations further comprises providing, by at least one processor, a control signal for stopping on the shoulder of a road upon determining that switching to manual driving is not performed until traveling of the vehicle along the emergency travel routes ends.

19. The operating method according to claim 17, wherein the performing of different control operations further comprises providing, by at least one processor, a control signal for causing the vehicle to gradually reduce the travel speed in a lane in which the vehicle is traveling and then stop upon determining that switching to manual driving is not performed until traveling of the vehicle along the emergency travel routes ends.

20. The operating method according to claim 19, wherein the performing of different control operations further comprises storing, by at least one processor, data generated after a malfunction has occurred and providing the data to an external device of the vehicle.
